(19) United States
(12) Patent Application Publication
(10) Pub. No.: US 2026/0094372 A1
(43) Pub. Date: Apr. 2, 2026

(54) TECHNIQUES FOR GENERATING VIRTUAL OBJECTS USING LATENT DIFFUSION MODELS

(71) Applicant: AUTODESK, INC., San Francisco, CA (US)

(72) Inventors: Aditya SANGHI, Toronto (CA); Hooman SHAYANI, Rochester (GB); Derek CHEUNG, Toronto (CA); Chinthala Pradyumna REDDY, London (GB); Kanika MADAN, Toronto (CA); Kamal Rahimi MALEKSHAN, Toronto (CA); Arianna RAMPINI, Ciampino (IT); Aliasghar KHANI, Vancouver (CA)

(21) Appl. No.: 19/286,770

(22) Filed: Jul. 31, 2025

Related U.S. Application Data
(60) Provisional application No. 63/702,105, filed on Oct. 1, 2024.

(51) Int. Cl. G06T 17/20; G06N 20/00

(52) U.S. Cl. CPC G06T 17/20; G06N 20/00

(57) ABSTRACT

One embodiment sets forth a technique for generating virtual objects. According to some embodiments, the technique includes generating, based on object data, compressed object data; performing, based on the compressed object data, one or more operations to train an untrained machine learning model to generate a trained machine learning model that comprises a trained decoder, where the trained machine learning model is trained to generate a reconstruction of the compressed object data; and generating, based on one or more conditions, a predicted virtual object using a trained diffusion model and the trained decoder.

### CROSS-REFERENCE TO RELATED APPLICATIONS

This application claims priority benefit of the U.S. Provisional Patent Application titled, “TECHNIQUES FOR ENCODING WAVELETS FOR TRAINING MACHINE LEARNING MODELS,” filed on Oct. 1, 2024, and having Ser. No. 63/702,105. The subject matter of this related application is hereby incorporated herein by reference.

### BACKGROUND

### Technical Field

Embodiments of the present disclosure relate generally to computer graphics, artificial intelligence, and machine learning, and, more specifically, to techniques for generating virtual objects using latent diffusion models.

### Description of the Related Art

Virtual object generation refers to the creation of digital representations of physical objects within simulated environments, augmented environments, virtual environments, or other environments. Virtual objects can include two-dimensional (2D) icons or assets, three-dimensional (3D) objects, animated characters, or other computer-generated structures. Virtual objects are commonly used in applications such as digital content creation, virtual and augmented reality (VR/AR), video games, simulations, digital twins, education, online commerce, and similar fields. For example, 3D objects—such as furniture, vehicles, anatomical parts, or household items—can be generated and placed into interactive scenes for visualization and interaction. In industrial design and prototyping, virtual objects enable rapid iteration without the need to perform intermediate physical manufacturing of models, prototypes, and similar elements. In entertainment and gaming, generated virtual characters and properties can populate immersive environments. In robotics and simulation, virtual objects can model obstacles, tools, or goals.

Conventional approaches for generating virtual objects include the use of generative models. Generative models generate virtual objects by learning patterns from large object datasets and generating new digital content that reflects the structure, geometry, and/or semantics of the datasets. Generative models can operate on compressed object data representations, such as wavelet-tree representations, truncated signed distance functions (TSDFs), occupancy grids, or other spatially compact encodings. For example, a generative model can be trained to generate 3D models of chairs, vehicles, household items, or anatomical structures using wavelet-tree representations. Generative models can generate virtual objects unconditionally or in response to one or more conditioning inputs, such as images, point clouds, voxel grids, depth maps, sketches, or textual descriptions. In augmented and virtual reality environments, generative models can populate scenes with objects that match the intended context or style. In robotics simulation, generative models can generate tool-like objects or containers to support manipulation tasks. In digital content creation and e-commerce, generative models can generate product variants or visual previews that adapt to user input.

One drawback of the conventional approaches for generating virtual objects is that, even when generative models operate on compressed object data representations, input data remains large and high-dimensional. While more efficient than raw 3D grids or meshes, compressed object data representations—such as wavelet-tree representations—still require significant memory and computational resources, especially when used at scale across diverse object categories. For example, a TSDF of resolution 256³ can yield a wavelet-tree representation of size 46³×64, which is comparable in size to a high-resolution 2D image. Generative models trained directly on such compressed object data representations face limitations in training speed, batch size, and scalability, particularly when deploying large neural networks or processing millions of 3D object samples.

As the foregoing illustrates, what is needed in the art are more effective techniques for generating virtual objects using latent diffusion models.

### SUMMARY

One embodiment sets forth a computer-implemented method for generating virtual objects. According to some embodiments, the method includes the steps of generating, based on object data, compressed object data; performing, based on the compressed object data, one or more operations to train an untrained machine learning model to generate a trained machine learning model that comprises a trained decoder, where the trained machine learning model is trained to generate a reconstruction of the compressed object data; and generating, based on one or more conditions, a predicted virtual object using a trained diffusion model and the trained decoder.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques include training a discrete autoencoder, which permits converting compressed object data into lower-dimensional latent embeddings. The disclosed techniques also include training a generative diffusion model using latent embedding data rather than the higher-dimensional compressed object data, which reduces memory consumption and computation time per sample object data. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A illustrates how the model trainer of FIG. 1 trains a discrete autoencoder, according to various embodiments;

FIG. 3B illustrates how the model trainer of FIG. 1 trains a generative diffusion model, according to various embodiments;

FIG. 4 is a more detailed illustration of the virtual object generation application of FIG. 1, according to various embodiments;

FIG. 5 is a flow diagram of method steps for training the discrete autoencoder and the generative diffusion model, according to various embodiments;

FIG. 6 is a flow diagram of method steps for training the discrete autoencoder, according to various embodiments;

FIG. 7 is a flow diagram of method steps for training the generative diffusion model, according to various embodiments; and

FIG. 8 is a flow diagram of method steps for generating predicted virtual objects, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for . . .

The virtual object generation techniques of the present disclosure have many real-world applications. For example, the virtual object generation techniques could be used to generate virtual objects in virtual or augmented reality environments, video games, simulation platforms, or digital content creation pipelines. As another example, the virtual object generation techniques can be used in domains, such as architecture, education, or entertainment.

The above examples are not in any way intended to be limiting. As persons skilled in the art will appreciate, as a general matter, the virtual object generation techniques described herein can be implemented in any suitable application.

### System Overview

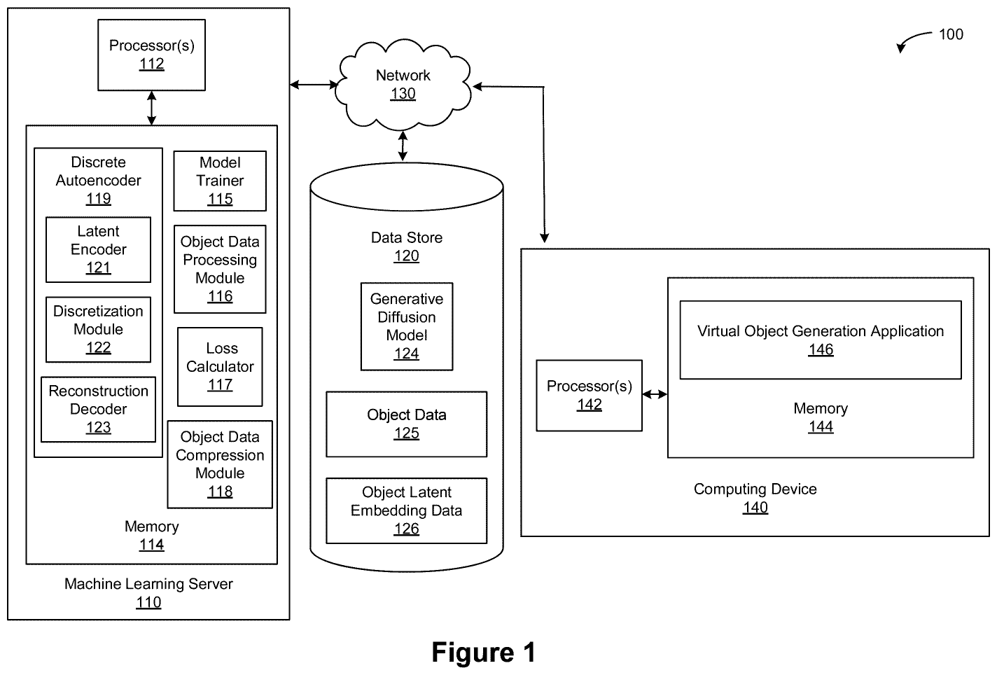

FIG. 1 illustrates a block diagram of a computer-based system 100 configured to implement one or more aspects of at least one embodiment. As shown, system 100 includes a machine learning server 110, a data store 120, and a computing device 140 in communication over a network 130. Network 130 can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, an object data processing module 116, a loss calculator 117, an object data compression module 118, and a discrete autoencoder 119. Discrete autoencoder 119 includes, without limitation, a latent encoder 121, a discretization module 122, and a reconstruction decoder 123. Data store 120 includes, without limitation, a generative diffusion model 124, object data 125, and object latent embedding data 126. Computing device 140 includes, without limitation, processor(s) 142 and a memory 144. Memory 144 includes, without limitation, a virtual object generation application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or similar technologies.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPUs can be included in and/or replaced with any type of virtual computing system, distributed computing system, and/or cloud computing environment, such as a public, private, or hybrid cloud system.

As shown, object data processing module 116 executes on one or more processors 112 of machine learning server 110 and is stored in system memory 114 of machine learning server 110. In various embodiments, object data processing module 116 is an application that processes object data 125 stored in data store 120 to generate processed object data. Object data 125, which can be stored in data store 120 or elsewhere (e.g., in memory 114), includes digital representations of physical or synthetic objects. In some examples, object data 125 can include 3D geometry, such as meshes, surface models, volumetric scans, point clouds, and/or similar structures. Object data 125 can be sourced from real-world sensors, 3D design tools, public datasets, and/or similar sources. The processed object data includes standardized or normalized representations derived from object data 125. In some implementations, object data processing module 116 converts object data 125 into truncated signed distance fields (TSDFs), voxel grids, or other volumetric formats that are suitable for further transformation, compression, or machine learning workflows. The processed object data can be generated at a fixed resolution, aligned to a canonical reference frame, or otherwise preconditioned for consistent downstream use.

As shown, loss calculator 117 executes on one or more processors 112 of machine learning server 110 and is stored in system memory 114 of machine learning server 110. In various embodiments, loss calculator 117 is an application that calculates a first loss based on reconstructed object data and compressed object data and calculates a second loss based on an added noise and a predicted noise.

As shown, object data compression module 118 executes on one or more processors 112 of machine learning server 110 and is stored in system memory 114 of machine learning server 110. In various embodiments, object data compression module 118 processes the processed object data and generates compressed object data. The compressed object data includes compact representations derived from the processed object data, such as wavelet-tree representations or other multi-resolution encodings that preserve geometric detail while reducing memory and computational requirements. For example, the compressed object data can include hierarchical wavelet coefficient grids, downsampled multi-scale voxel representations, or sparse tensor encodings that capture localized features.

As shown, model trainer 115 is an application that executes on one or more processors 112 of machine learning server 110 and is stored in a system memory 114 of machine learning server 110. Although shown as distinct from object data processing module 116, loss calculator 117, and object data compression module 118 for illustrative purposes, in some embodiments, functionality of object data processing module 116, loss calculator 117, object data compression module 118, and model trainer 115 can be combined into a single application or separated into any number of applications.

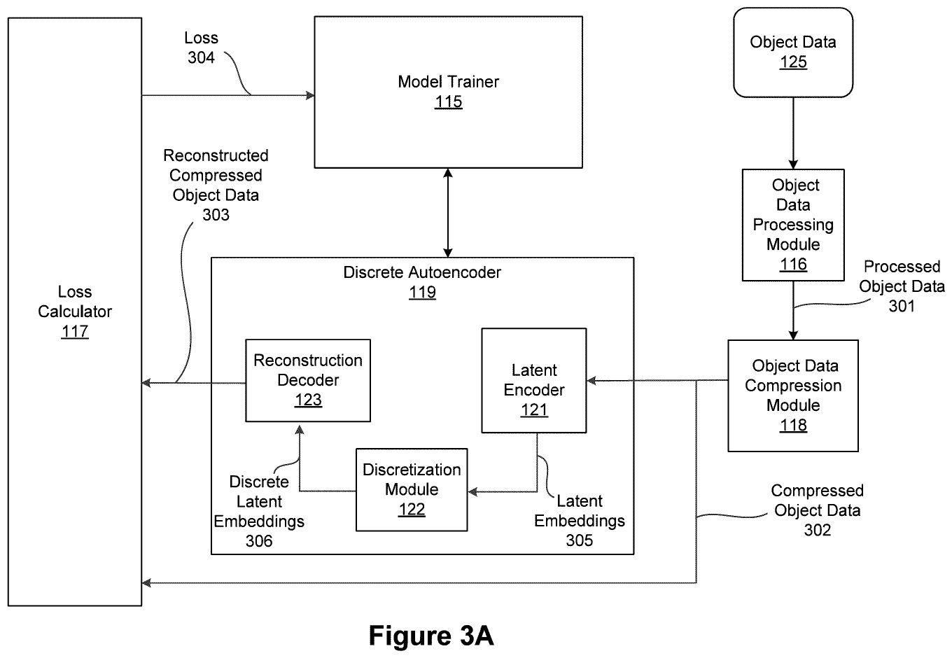

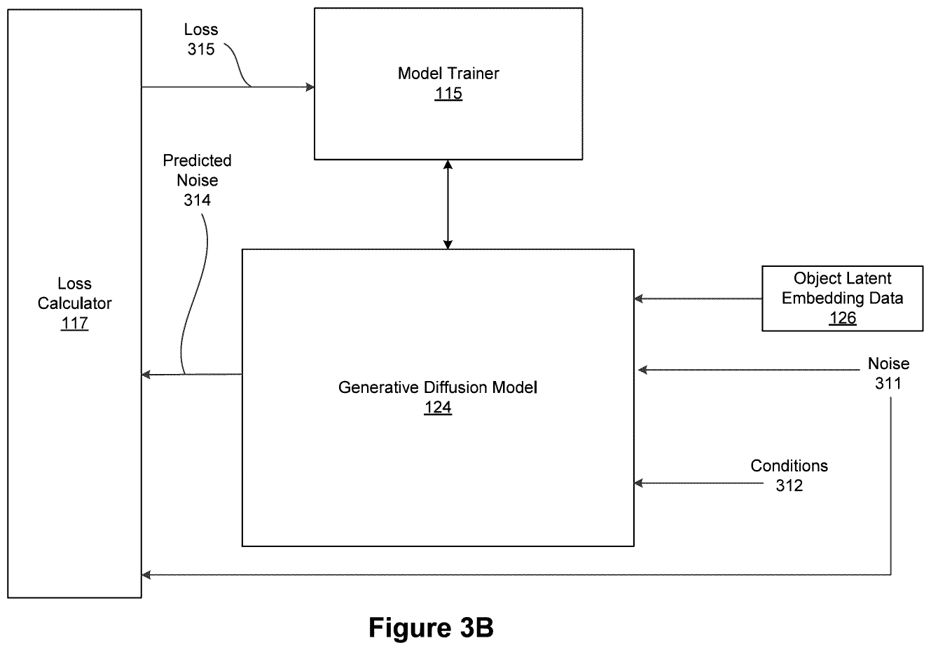

In some embodiments, model trainer 115 is configured to train one or more machine learning models, including discrete autoencoder 119 and generative diffusion model 124. Discrete autoencoder 119 is a machine learning model, such as a neural network, which is trained to generate reconstructed compressed object data based on compressed object data. Generative diffusion model 124 is another machine learning model, such as a neural network, which processes one or more conditions received via one or more I/O devices (not shown) and generates a predicted latent embedding. Techniques for training discrete autoencoder 119 based on object data 125 and training generative diffusion model 124 based on object latent embedding data 126 are discussed in greater detail herein in conjunction with at least FIGS. 3A-3B and 5-7. Generative diffusion model 124 can be stored in data store 120. In some embodiments, data store 120 can include any storage device or devices, such as fixed disc drive(s), flash drive(s), optical storage, network-attached storage (NAS), and/or a storage area network (SAN). Although shown as accessible over network 130, in at least one embodiment machine learning server 110 can include data store 120.

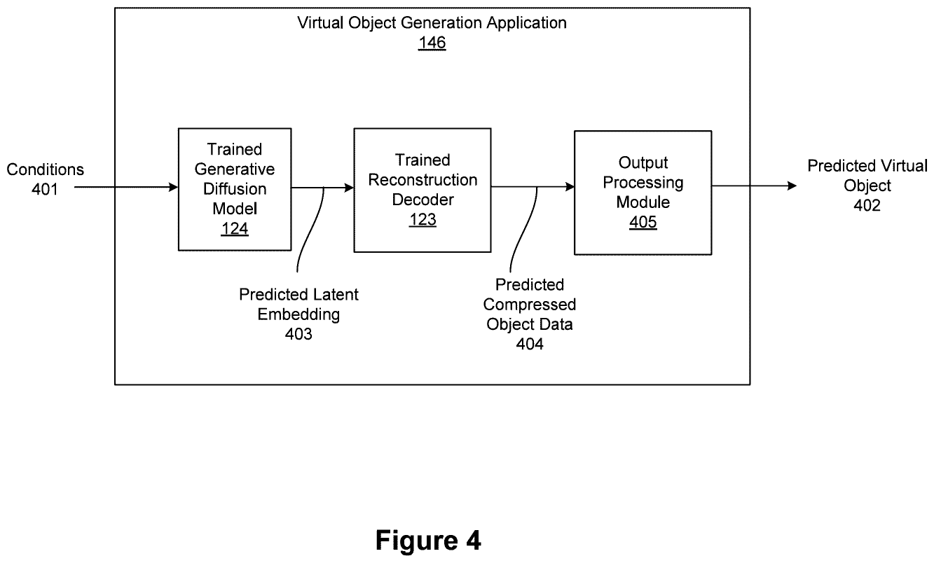

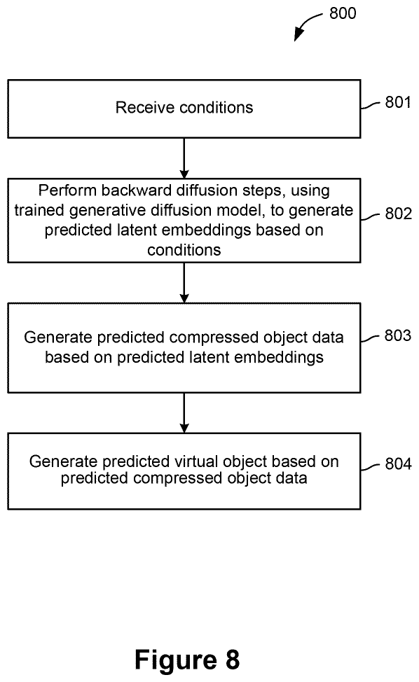

As shown, virtual object generation application 146 uses generative diffusion model 124, which is stored in data store 120 and accessed over network 130, and reconstruction decoder 123 and executes on processor(s) 142 of computing device 140. Once trained, generative diffusion model 124 along with trained reconstruction decoder 123 can be deployed, such as via virtual object generation application 146, to generate a predicted virtual object. Virtual object generation application 146 is discussed in greater detail herein in conjunction with at least FIGS. 4 and 8. Memory 144 and processor(s) 142 can be similar to memory 114 and processor(s) 112 of machine learning server 110, described above.

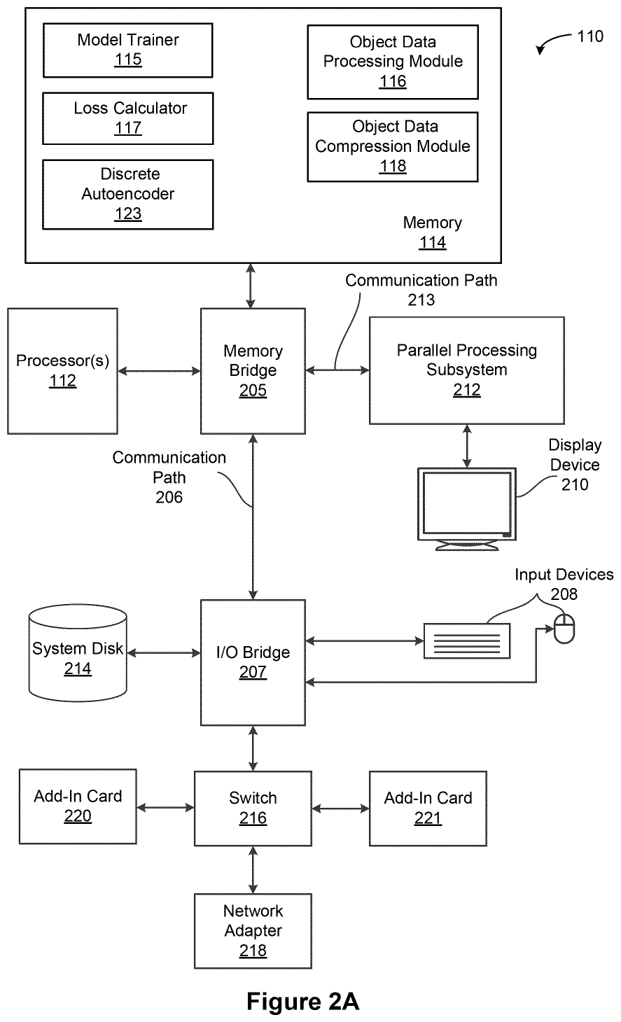

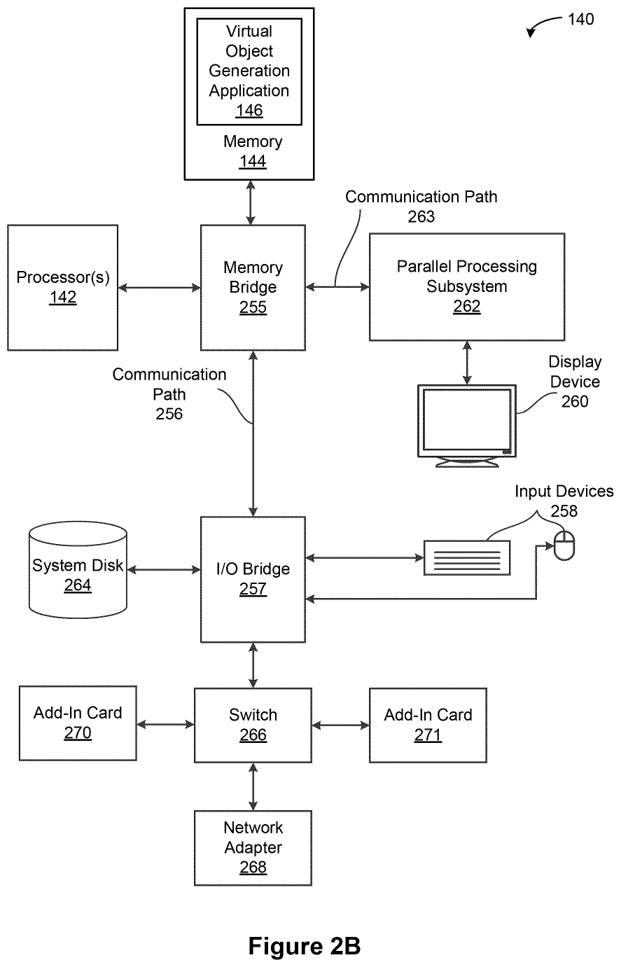

FIG. 2A provides a more detailed illustration of machine learning server 110 of FIG. 1, according to various embodiments. Machine learning server 110 may include any type of computing system, including, without limitation, a server machine, a server platform, a desktop machine, a laptop machine, a handheld/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or similar devices, and forward the input information to processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and similar components may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or similar technologies. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized for general purpose and/or compute processing. Again, such circuitry may be incorporated across one or more PPUs included within parallel processing subsystem 212, which are configured to perform such general-purpose and/or compute operations. In yet other embodiments, the one or more PPUs included within parallel processing subsystem 212 may be configured to perform graphics processing, general-purpose processing, and/or compute processing operations. System memory 114 includes at least one device driver configured to manage the processing operations of the one or more PPUs within parallel processing subsystem 212. In addition, system memory 114 includes, without limitation, model trainer 115, object data processing module 116, loss calculator 117, object data compression module 118, and discrete autoencoder 119. Although described herein primarily with respect to model trainer 115, object data processing module 116, loss calculator 117, object data compression module 118, and a discrete autoencoder 119, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In some embodiments, one or more components shown in FIG. 2A may not be present. For example, switch 216 could be eliminated, and network adapter 218 and add-in cards 220, 221 would connect directly to I/O bridge 207. Lastly, in some embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B provides a more detailed illustration of computing device 140 of FIG. 1, according to various embodiments. Computing device 140 may include any type of computing system, including, without limitation, a server machine, a server platform, a desktop machine, a laptop machine, a handheld/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or similar devices, and forward the input information to processor(s) 142 for processing. In some embodiments, computing device 140 may be a server machine in a cloud computing environment. In such embodiments, computing device 140 may not include input devices 258 but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and similar components may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or similar technologies. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized for general purpose and/or compute processing. Again, such circuitry may be incorporated across one or more PPUs included within parallel processing subsystem 262, which are configured to perform such general-purpose and/or compute operations. In yet other embodiments, the one or more PPUs included within parallel processing subsystem 262 may be configured to perform graphics processing, general-purpose processing, and/or compute processing operations. System memory 144 includes at least one device driver configured to manage the processing operations of the one or more PPUs within parallel processing subsystem 262. In addition, system memory 144 includes virtual object generation application 146. Although described herein primarily with respect to virtual object generation application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In some embodiments, one or more components shown in FIG. 2B may not be present. For example, switch 266 could be eliminated, and network adapter 268 and add-in cards 270, 271 would connect directly to I/O bridge 257. Lastly, in some embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Discrete Autoencoder Using Compressed Object Data

FIG. 3A illustrates how the model trainer 115 trains discrete autoencoder 119, according to various embodiments. As shown, discrete autoencoder 119 includes, without limitation, latent encoder 121, discretization module 122, and reconstruction decoder 123. In operation, object data processing module 116 processes object data 125 and generates processed object data 301. Object data compression module 118 processes processed object data 301 and generates compressed object data 302. Latent encoder 121 processes compressed object data 302 and generates latent embeddings 305. Discretization module 122 processes latent embeddings 305 and generates discrete latent embeddings 306. Reconstruction decoder 123 processes discrete latent embeddings 306 and generates reconstructed compressed object data 303. Loss calculator 117 compares reconstructed compressed object data 303 with compressed object data 302 and calculates loss 304. Model trainer 115 uses loss 304 to iteratively update parameters of discrete autoencoder 119 until one or more stopping criteria are met.

Object data processing module 116 is an application that processes object data 125 and generates processed object data 301. In various embodiments, the processing of object data 125 includes converting object data 125 into volumetric representations using a signed distance field (SDF) TSDF format at a fixed resolution, such as 256×256×256 voxels. In some embodiments, object data processing module 116 further normalizes each object included in object data 125 to fit within a unit cube and center the object at the origin. Object data processing module 116 also applies surface extraction, watertight remeshing, mesh cleaning operations, and/or the like, as a preprocessing step when starting from non-volumetric inputs, such as triangle meshes or point clouds. In some embodiments, object data processing module 116 rasterizes input object meshes included in object data 125 into TSDFs using voxelization algorithms, GPU-based raycasting techniques, and/or the like. In some embodiments, object data processing module 116 performs additional processing steps, such as band-level decomposition, occupancy filtering, or value truncation (e.g., clamping TSDF values to a narrow band around the zero level set) to reduce unnecessary information included in object data 125.

Object data compression module 118 is an application that processes processed object data 301 and generates compressed object data 302. In various embodiments, object data compression module 118 applies a 3D wavelet transform to the volumetric processed object data 301 Sₙ, such as a TSDF of resolution 256³. The transform decomposes the volumetric field into a hierarchical set of wavelet coefficients that capture spatial frequency information at multiple scales. The resulting compressed representation is referred to as a wavelet-tree representation Wₙ␣ [symbol] , which encodes both coarse and fine object details through structured band-level decomposition. For example, the wavelet-tree can include 46³ distinct 3D spatial locations (e.g., wavelet nodes), with each location storing a 64-dimensional feature vector composed of 1 low-frequency coefficient C₀, 27 directional detail coefficients D₀, and 36 directional residuals D₁, forming a tensor of shape 46³×64. In some embodiments, object data compression module 118 performs the wavelet transform using Haar or other separable basis functions along the x, y, and z axes, resulting in anisotropic frequency bands that localize changes along specific spatial directions. In some examples, the compression process can include additional post-transform steps, such as thresholding, zero-masking, or lossless encoding of sparse coefficients to further reduce storage size. In some embodiments, object data compression module 118 selectively drops or downsamples high-frequency bands based on a masking function or importance weighting, thereby controlling the reconstruction fidelity versus storage trade-off.

Discrete autoencoder 119 is a machine learning model, such as a neural network, which processes compressed object data 302 and generates reconstructed compressed object data 303. In some examples, discrete autoencoder 119 is implemented by a Vector-Quantized Variational Autoencoder (VQ-VAE) or a VQ-VAE-2 model. The VQ-VAE or a VQ-VAE-2 architectures are designed to compress high-dimensional inputs into discrete latent spaces and are suited for generative modeling tasks involving images, audio, or 3D data. Other example implementations of discrete autoencoder 119 can include multi-level VQ-VAEs, hierarchical quantization schemes, or hybrid architectures that combine convolutional encoders with transformer-based decoders.

As shown, discrete autoencoder 119 includes latent encoder 121, discretization module 122, and reconstruction decoder 123. Latent encoder 121 is a machine learning model, such as a neural network, which processes compressed object data 302 and generates latent embeddings 305. In various embodiments, latent encoder 121 receives compressed object data 302 in the form of high-dimensional volumetric representations, such as wavelet-tree encodings Wₙ∈ [symbol] , and transforms compressed object data 302 into a lower-dimensional latent representation Zₙ (e.g., latent embeddings 305) suitable for discrete tokenization. In some embodiments, latent encoder 121 includes multiple layers of 3D convolutions, nonlinear activations, and normalization layers that progressively reduce the spatial dimensions and channel width of the input tensor Wₙ while preserving semantically meaningful features. For example, latent encoder 121 can convert compressed object data 302 of size 46×46×46×64 into a latent embedding grid Zₙ∈ [symbol] , where d is the latent embedding dimensionality (e.g., 4, 8, or 16). Latent embeddings 305 include dense, continuous-valued vectors that summarize local regions of the input compressed object data 302. Latent embeddings 305 are designed to include both coarse and fine structural information from the original data included in compressed object data 302 in a form that can be efficiently discretized and reconstructed.

Discretization module 122 is an application that processes latent embeddings 305 and generates discrete latent embeddings 306. In various embodiments, discretization module 122 performs a vector quantization operation in which each continuous-valued latent vector included in latent embeddings 305, denoted Zₙ∈ [symbol] , is replaced with the nearest vector from a learned codebook. The process converts the continuous latent grid Zₙ into a quantized grid VQ(Zₙ), consisting of discrete embedding vectors or corresponding token indices. For example, the codebook can include a fixed number of embedding vectors (e.g., 512 or 1024), each of which resides in the same d-dimensional space as the latent embeddings 305 (e.g., d=4, 8, or 16). In some embodiments, discretization module 122 uses a nearest-neighbor matching approach based on Euclidean distance or another similarity metric. The selected codebook entries are substituted for the original latent vectors in Zₙ, resulting in discrete latent embeddings 306, which retain the same spatial structure (e.g., a 12×12×12 grid) but contain quantized values. In some embodiments, discretization module 122 supports straight-through gradient estimation or other differentiable approximations to enable end-to-end training of discrete autoencoder 119.

Reconstruction decoder 123 is a machine learning model, such as a neural network, that processes discrete latent embeddings 306 and generates reconstructed compressed object data 303. In various embodiments, reconstruction decoder 123 receives a spatial grid included in discrete latent embeddings 306, denoted VQ(Zₙ)∈ [symbol] , where each token corresponds to an entry in a learned codebook, and transforms this grid into a high-resolution output

$${W}_{n}^{′}$$

that approximates the original compressed object data 302 Wₙ. In some embodiments, reconstruction decoder 123 includes a stack of 3D convolutional layers, transposed convolutions (e.g., deconvolutions), residual blocks, or other neural network components designed to progressively upsample and refine spatial features from the latent space. In some embodiments, reconstruction decoder 123 also includes skip connections, attention mechanisms, normalization layers, and/or the like. In various embodiments, reconstruction decoder 123 reconstructs compressed object data 303 in the same format as the original input to latent encoder 121, such as a wavelet-tree representation of shape 46×46×46×64. The reconstructed output

$${W}_{n}^{′}$$

includes multi-resolution frequency coefficients, such as

$${C}_{0}^{′} , {D}_{0}^{′} , and {D}_{1}^{′} ,$$

that approximate the geometry and structure of the original 3D object encoded in the compressed object data 302.

Loss calculator 117 is an application that compares compressed object data 302 with reconstructed compressed object data 303 and calculates loss 304. In various embodiments, compressed object data 302 corresponds to a wavelet-tree representation (e.g., Wₙ∈ [symbol] ), and reconstructed compressed object data 303 corresponds to

$${W}_{{n}^{′}}^{′}$$

a reconstructed version generated reconstruction decoder 123. Loss calculator 117 calculates a reconstruction loss [symbol] _{rec} between Wₙ and

$${W}_{n}^{′}$$

that accounts for both low-frequency and high-frequency components in the wavelet domain. In some examples, the reconstruction loss is defined as:

$${ℒ}_{rec} = MSE ( {C}_{0} , {C}_{0}^{′} ) + \frac{1}{2} {\sum }_{D ∈ \{ {D}_{0} , {D}_{1} \}} [ MSE ( D [ {P}_{0} ] , {D}^{′} [ {P}_{0} ] ) + MSE ( R ( D [ {P}_{0}^{′} ] ) , R ( {D}^{′} [ {P}_{0}^{′} ] ) ) ] , \qquad ( Equation 1 )$$

where C₀ and

$${C}_{0}^{′}$$

are the low-frequency coefficients of the original compressed object data 302 and reconstructed compressed object data 303, D₀ and D₁ are high-frequency wavelet bands,

$${D}_{0}^{′} and {D}_{1}^{′}$$

are the corresponding reconstructions of D₀ and D₁, P₀ is the set of coordinates associated with the highest-magnitude coefficients, and R(⋅) denotes a randomized subset of positions. The function MSE(a, b) refers to the mean squared error between tensors a and b, computed as the average of the squared differences between corresponding elements. In some embodiments, loss calculator 117 also calculates auxiliary loss terms to support vector quantization during training. The auxiliary losses include a codebook loss

$${ℒ}_{codebook} = {‖ sg [ {Z}_{n} ] - e ‖}_{2}^{2}$$

and a commitment, loss

$${ℒ}_{commit} = β \cdot {‖ {Z}_{n} - sg [ e ] ‖}_{2}^{2} ,$$

where Zₙ is the latent embedding 305, e is a selected codebook vector, sg[⋅] is the stop-gradient operator, and β is a hyperparameter controlling the strength of the commitment term. In some embodiments, loss calculator 117 calculates loss 304 based on at least one of the reconstruction loss, the commitment loss, and the codebook loss. For example, loss 304 can be defined as the sum of the reconstruction, codebook, and commitment losses:

$${ℒ}_{total} = {ℒ}_{rec} + {ℒ}_{codebook} + {ℒ}_{commit} . \qquad ( Equation 2 )$$

Model trainer 115 uses loss 304 to iteratively update the parameters of discrete autoencoder 119. In various embodiments, model trainer 115 performs gradient-based optimization, such as stochastic gradient descent (SGD), adaptive moment estimation (Adam), and/or the like, to minimize loss 304 by adjusting the parameters of latent encoder 121, reconstruction decoder 123, and the codebook used by discretization module 122. In some examples, gradients are computed via backpropagation across loss 304, which can include reconstruction, codebook, and commitment losses. In some embodiments, to improve convergence and training stability, model trainer 115 applies additional techniques, such as learning rate scheduling, gradient clipping, parameter regularization, and/or the like. In some embodiments, model trainer 115 initially trains discrete autoencoder 119 using a large corpus of training samples collected from multiple datasets. For example, the training data (e.g., object data 125) can include millions of samples aggregated from heterogeneous sources, such as computer-assisted design (CAD) models, scanned objects, or synthetic assets. Whenever the training dataset distribution is imbalanced (e.g., skewed toward simpler objects), model trainer 115 applies a balanced fine-tuning stage following the initial training phase. During balanced fine-tuning, model trainer 115 exposes discrete autoencoder 119 to an equal number of samples from each dataset or object category to mitigate dataset bias and improve generalization across underrepresented or more complex 3D shapes. In some embodiments, model trainer 115 trains discrete autoencoder 119 until a specified stopping criterion is met. In some embodiments, the stopping criterion is based on convergence of loss 304, such as when loss 304 plateaus or falls below a predefined threshold. In some embodiments, training stops after a fixed number of epochs, iterations, or wall-clock time, or based on early-stopping criteria evaluated on a validation set (e.g., when a validation loss does not improve for a predefined number of checkpoints). Once training is complete, the trained discrete autoencoder 119 can be stored in memory 114, data store 120, or elsewhere.

### Training Generative Diffusion Model Using Object Latent Embedding Data

FIG. 3B illustrates how model trainer 115 trains generative diffusion model 124, according to various embodiments. As shown, generative diffusion model 124 processes object latent embedding data 126, noise 311, and one or more conditions 312 to generate predicted noise 314. Loss calculator 117 compares noise 311 with predicted noise 314 and calculates loss 315. Model trainer 115 uses loss 315 to iteratively update parameters of generative diffusion model 124 until one or more stopping criteria are met.

Generative diffusion model 124 is a machine learning model, such as a neural network, that processes noise 311, object latent embedding data 126, and conditions 312 to generate predicted noise 314. In various embodiments, object latent embedding data 126 includes clean latent embeddings (e.g.,

$${Z}_{n}^{0}$$

∈ [symbol] ), which encodes a compressed representation of an object. For example, object latent embedding data 126 can be generated by processing compressed representations of object data 125 using the trained latent encoder 121. In various embodiments, generative diffusion model 124 performs forward diffusion steps to generate a noisy laten embedding

$${Z}_{n}^{t}$$

by corrupting

$${Z}_{n}^{0}$$

with Gaussian noise 3111 according to a noise schedule, such as cosine noise schedule. In some examples, the forward corruption is defined as:

$${Z}_{n}^{t} = \sqrt{{\overline{α}}_{t}} \cdot {Z}_{n}^{0} + \sqrt{1 - {\overline{α}}_{t}} \cdot ϵ , \qquad ( Equation 3 )$$

where ϵ˜ [symbol] (0, 1) and α̅ₜ is a timestep-dependent scalar defined by a variance schedule that smoothly decreases the signal-to-noise ratio as t increases. The noise corruption process generates a latent variable

$${Z}_{n}^{t}$$

that becomes increasingly noisy with larger timesteps. In some embodiments, generative diffusion model 124 includes pre-trained condition encoders that process conditions 312 and generate a condition vector Θₙ. Condition vector Θₙ is a latent set of vectors computed from one or more conditions 312, such as single-view or multi-view images, voxelizations, point clouds, texts, sketches, and/or the like. In some embodiments, generative diffusion model 124 includes cross-attention mechanisms and feature modulation to process condition vectors. In some examples, generative diffusion model 124 is implemented as a Unified Vision Transformer (U-ViT) generator, where Θₙ influences the generation process by acting as the source of keys and values in the crossattention layers and by modulating the normalization parameters in Residual Network (ResNet) and cross-attention blocks. In various embodiments, generative diffusion model 124 is parameterized by a neural network function ƒ_{θ}, where θ denotes the set of parameters. Generative diffusion model 124 processes noisy latent embedding

$${Z}_{n}^{t} ,$$

the timestep t, and the condition vector Θₙ, and generates predicted noise 314 \hat{ϵ} as follows:

$$\hat{ε} = {f}_{θ} ( {Z}_{n}^{t} , t , {Θ}_{n} ) , \qquad ( Equation 4 )$$

Predicted noise 314 \hat{ϵ} approximates the original noise 311 ϵ that was used to generate

$${Z}_{n}^{t}$$

from

$${Z}_{n}^{0} .$$

Loss calculator 117 compares noise 311 with predicted noise 314 and calculates loss 315. In some examples, loss calculator 117 computes a denoising loss 315 [symbol] _{diff} based on noise 311 and predicted noise 314 using a mean squared error function:

$${ℒ}_{diff} = [ {‖ {f}_{θ} ( {Z}_{n}^{t} , t , {Θ}_{n} ) - ϵ ‖}_{2}^{2} ] , \qquad ( Equation 5 )$$

where the function

$${‖ \cdot ‖}_{2}^{2}$$

denotes the squared L2 norm, which computes the average squared difference between corresponding elements of the predicted and true noise tensors.

Model trainer 115 uses loss 315 to update parameters of generative diffusion model 124. In various embodiments, model trainer 115 performs gradient-based optimization, such as SGD, Adam, and/or the like, to minimize the denoising loss [symbol] _{diff} by adjusting the parameters θ of the generative diffusion model 124 ƒ_{θ}. In some embodiments, model trainer 115 trains generative diffusion model 124 iteratively over batches of training samples that include clean latent embeddings included in object latent embedding data 126, sampled noise 311, conditions 312, and diffusion timesteps. To ensure stability and generalization across different noise levels, the timestep t is sampled uniformly from a fixed range (e.g., t∈{1, . . . , T=10}), and the corresponding scaling coefficients α̅ₜ are derived from a noise schedule, such as a cosine noise schedule. In some embodiments, model trainer 115 applies learning rate scheduling, gradient clipping, mixed-precision training, and/or the like, to improve convergence efficiency. In some embodiments, training of generative diffusion model 124 continues until a predefined stopping criterion is met. For example, model trainer 115 could terminate training after a fixed number of epochs, after a convergence threshold is reached for loss 315, or based on early-stopping criteria measured on a validation dataset. Once training is complete, the trained generative diffusion model 124 can be stored in data store 120 or elsewhere.

### Virtual Object Generation Using Trained Generative Diffusion Model and Trained Reconstruction Decoder

FIG. 4 is a more detailed illustration of virtual object generation application 146, according to various embodiments. As shown, virtual object generation application 146 includes trained generative diffusion model 124, trained reconstruction decoder 123, and output processing module 405. In operation, trained object generation application 146 processes conditions 401 received from one or more I/O devices and generates predicted latent embedding 403. Trained reconstruction decoder 123 processes predicted latent embedding 403 and generates predicted compressed object data 404. Output processing module 405 processes predicted compressed object data 404 and generates predicted virtual object 402.

Virtual object generation application 146 is an application that processes conditions 401 and generates predicted virtual object 402. In some embodiments, virtual object generation application 146 uses trained generative diffusion model 124 to process conditions 401 and generate predicted latent embedding 403. Conditions 401 include one or more input modalities, such as single-view or multi-view images, depth maps, sketches, point clouds, voxel grids, text, and/or the like. In some embodiments, trained generative diffusion model 124 includes one or more modality-specific condition encoders that process conditions 401 and generate a shared conditioning vector Θₙ. In some embodiments, virtual object generation application 146 initially samples a latent tensor

$${Z}_{n}^{T} ∼ 𝒩 ( 0 , I ) ,$$

representing an isotropic Gaussian noise sample in the latent embedding space. Virtual object generation application 146 then performs one or more backward diffusion steps using trained generative diffusion model 124 to progressively refine the latent tensor

$${Z}_{n}^{T} .$$

At each timestep t∈{T, T−1, . . . 1}, trained generative diffusion model 124 ƒ_{θ} receives the current latent

$${Z}_{n}^{t} ,$$

the timestep t, and the condition vector Θₙ, and predicts the noise \hat{ϵ}ₜ using Equation 4. Using the predicted noise \hat{ϵ}ₜ, virtual object generation application 146 computes the denoised latent

$${Z}_{n}^{t - 1} .$$

In some examples, virtual object generation application 146 computes the denoised latent based on the standard Denoising Diffusion Probabilistic Model (DDPM) reverse update rule:

$${Z}_{n}^{t - 1} = \frac{1}{\sqrt{{α}_{t}}} ( {Z}_{n}^{t} - \frac{1 - {α}_{t}}{\sqrt{1 - {\overline{α}}_{t}}} \cdot {\hat{ϵ}}_{t} ) + {σ}_{t} \cdot η , \qquad ( Equation 6 )$$

where αₜ and α̅ₜ are scalar coefficients from a noise schedule, σₜ is the standard deviation of the reverse noise at timestep t, and η˜ [symbol] (0, 1) is an optional Gaussian noise term used for stochastic sampling, which may be omitted at t=1. Once the iteration in Equation 6 reaches t=1, trained generative diffusion model 124 generates predicted latent embedding

$$403 {Z}_{n}^{0} .$$

In some embodiments, virtual object generation application 146 applies classifier-free guidance to steer generation of predicted latent embeddings 403 toward the conditional distribution by interpolating between the unconditional and conditional predictions of trained generative diffusion model 124. The interpolation permits dynamic control over the trade-off between output quality and diversity. In some embodiments, virtual object generation application 146 varies the initial latent sample

$${Z}_{n}^{T}$$

to generate multiple diverse outputs for the same input conditions 401.

Trained reconstruction decoder 123 processes predicted latent embedding 403 and generates predicted compressed object data 404. In some embodiments, trained reconstruction decoder 123 processes predicted latent embedding 403 (e.g.,

$${Z}_{n}^{0}$$

∈ [symbol] and transforms predicted latent embedding 403 into a high-resolution output in the same format as the original compressed object data 302, such as a wavelet-tree tensor of shape 46×46×46×64. In various embodiments, predicted compressed object data 404 includes a multiscale or frequency-domain representation of a 3D object, such as a wavelet-tree tensor encoding both coarse structural components and fine-grained geometric detail.

Output processing module 405 is an application that processes predicted compressed object data 404 and generates predicted virtual object 402. In some embodiments, output processing module 405 decodes multiscale or frequency-domain representation included in predicted compressed object data 404 into a spatial domain format. For example, when predicted compressed object data 404 is represented as a wavelet-tree tensor, output processing module 405 performs an inverse wavelet transform to reconstruct the underlying volumetric field or surface representation. In some embodiments, output processing module 405 also performs auxiliary operations over the spatial domain format, such as scaling, translation, alignment to a canonical frame, or metadata attachment (e.g., labels, categories, or part segmentation). The output format of predicted virtual object 402 varies depending on the application. For example, output processing module 405 can reconstruct a dense volumetric field, such as a TSDF, from which a surface mesh can be extracted using algorithms, such as Marching Cubes, Dual Contouring, and/or the like. In other examples, predicted virtual object 402 can be a voxel grid with binary or probabilistic occupancy values, a polygon mesh composed of vertices and faces, a textured mesh with material and shading attributes, or a point cloud representing sampled surface geometry.

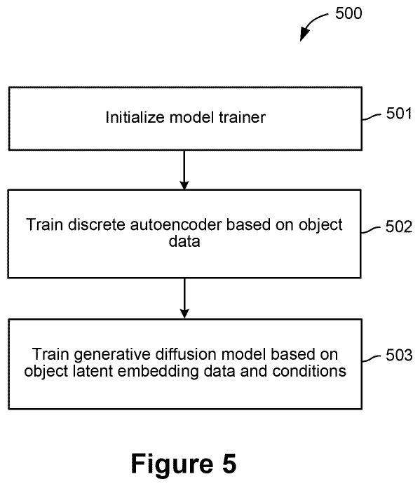

FIG. 5 is a flow diagram of method steps for training discrete autoencoder 123 and the generative diffusion model 124, according to various embodiments. Although the method steps are described in conjunction with the systems of FIGS. 1-4, persons skilled in the art will understand that any system configured to perform the method steps in any order falls within the scope of the present disclosure.

As shown, a method 500 begins with step 501, wherein model trainer 115 is initialized. In some embodiments, model trainer 115 initializes the training environment by selecting an optimization algorithm, such as the Adam, and assigning a learning rate (e.g., 0.0001) and gradient clipping threshold (e.g., 1.0) to ensure stable updates during backpropagation. In some embodiments, model trainer 115 initializes one or more training hyperparameters. For example, model trainer 115 sets the number of diffusion steps used by generative diffusion model 124 to a fixed value (e.g., 10). In some implementations, model trainer 115 initializes additional parameters associated with the noise schedule or variance schedule. In some examples, when training discrete autoencoder 119, model trainer 115 can initialize specific loss parameters, such as commitment loss weight, reconstruction loss weight, and codebook loss weight. In some embodiments, model trainer 115 also initializes one or more stopping criteria to determine when training ends. For example, model trainer 115 can set a fixed number of training iterations or epochs (e.g., 2 to 4 million), defining a threshold such that training ends whenever the total loss is below the threshold, setting an early stopping based on performance on a validation set, setting a maximum training runtime, and/or the like.

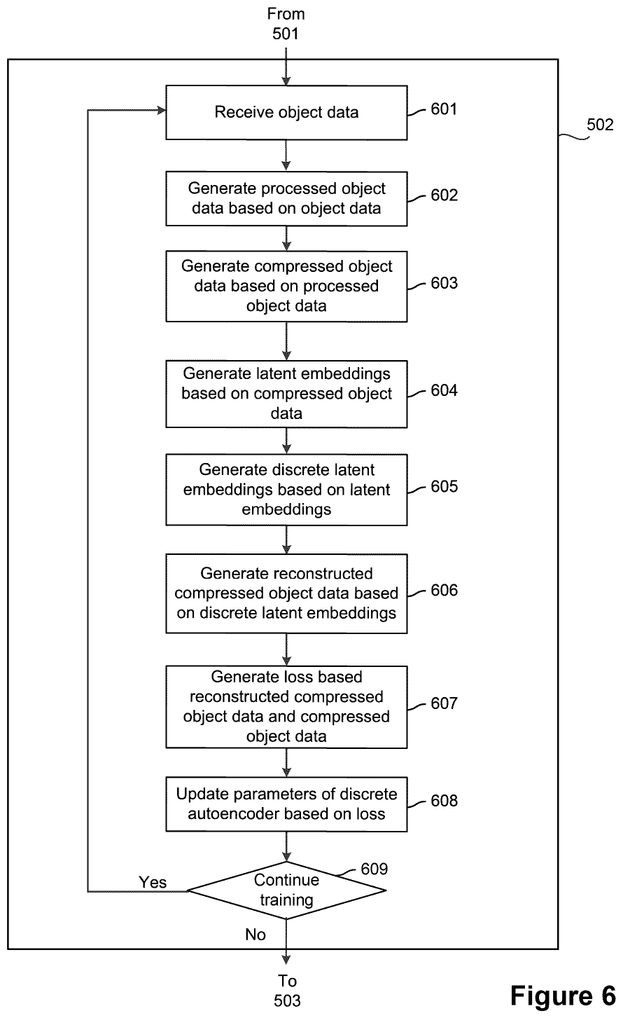

At step 502, model trainer 115 trains discrete autoencoder 119 based on object data 125. In some embodiments, object data processing module 116 processes object data 125 and generates processed object data 301. Object data compression module 118 processes processed object data 301 and generates compressed object data 302. Latent encoder 121 processes compressed object data 302 and generates latent embeddings 305. Discretization module 122 processes latent embeddings 305 and generates discrete latent embeddings 306. Reconstruction decoder 123 processes discrete latent embeddings 306 and generates reconstructed compressed object data 303. Loss calculator 117 compares reconstructed compressed object data 303 with compressed object data 302 and calculates loss 304. Model trainer 115 uses loss 304 to iteratively update parameters of discrete autoencoder 119 until one or more stopping criteria are met. Once training is complete, the trained discrete autoencoder 119 can be stored in memory 114, data store 120, or elsewhere. Step 502 is described in greater detail in conjunction with FIG. 6.

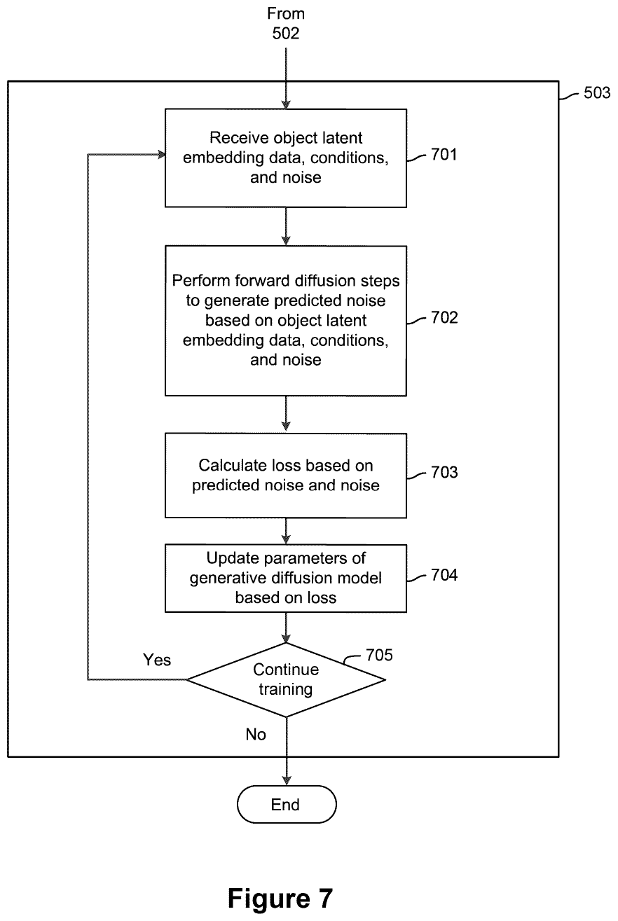

At step 503, model trainer 115 trains generative diffusion model 124 based on object latent embedding data 126 and conditions 312. In some embodiments, generative diffusion model 124 processes object latent embedding data 126, noise 311, and one or more conditions 312 to generate predicted noise 314. Loss calculator 117 compares noise 311 with predicted noise 314 and calculates loss 315. Model trainer 115 uses loss 315 to iteratively update parameters of generative diffusion model 124 until one or more stopping criteria are met. Once training is complete, the trained generative diffusion model 124 can be stored in data store 120 or elsewhere. Step 503 is described in greater detail in conjunction with FIG. 7.

FIG. 6 is a flow diagram of method steps for training discrete autoencoder 119, according to various embodiments. Although the method steps are described in conjunction with the systems of FIGS. 1-4, persons skilled in the art will understand that any system configured to perform the method steps in any order falls within the scope of the present disclosure.

As shown, step 502 of the method 500 begins with step 601, wherein object data processing module 116 receives object data 125. Object data 125 includes digital representations of physical or synthetic objects. In some examples, object data 125 can include 3D geometry, such as meshes, surface models, volumetric scans, point clouds, and/or the like. Object data 125 can be received from real-world sensors, 3D design tools, public datasets, and/or the like.

At step 602, object data processing module 116 generates processed object data 301 based on object data 125. In various embodiments, the processing of object data 125 includes converting object data 125 into volumetric representations using SDF or TSDF format at a fixed resolution. In some embodiments, object data processing module 116 further normalizes each object included in object data 125 to fit within a unit cube and center the object at the origin. Object data processing module 116 also applies surface extraction, watertight remeshing, mesh cleaning operations, and/or the like, as a preprocessing step when starting from non-volumetric inputs. In some embodiments, object data processing module 116 rasterizes input object meshes included in object data 125 into TSDFs using voxelization algorithms, GPU-based raycasting techniques, and/or the like. In some embodiments, object data processing module 116 performs additional processing steps, such as band-level decomposition, occupancy filtering, or value truncation to reduce unnecessary information included in object data 125.

At step 603, object data compression module 118 generates compressed object data 302 based on processed object data 301. In various embodiments, object data compression module 118 applies a 3D wavelet transform to the volumetric processed object data 301, which decomposes the volumetric field into a hierarchical set of wavelet coefficients that capture spatial frequency information at multiple scales. In some embodiments, object data compression module 118 performs the wavelet transform using Haar or other separable basis functions along the x, y, and z axes, resulting in anisotropic frequency bands that localize changes along specific spatial directions. In some examples, the compression process can include additional post-transform steps, such as thresholding, zero-masking, or lossless encoding of sparse coefficients to further reduce storage size. In some embodiments, object data compression module 118 selectively drops or downsamples high-frequency bands based on a masking function or importance weighting, thereby controlling the reconstruction fidelity versus storage trade-off.

At step 604, latent encoder 121 generates latent embeddings 305 based on compressed object data 302. In various embodiments, latent encoder 121 receives compressed object data 302 in the form of high-dimensional volumetric representations, such as wavelet-tree encodings, and transforms compressed object data 302 into a lower-dimensional latent representation (e.g., latent embeddings 305) suitable for discrete tokenization. In some embodiments, latent encoder 121 includes multiple layers of 3D convolutions, nonlinear activations, and normalization layers that progressively reduce the spatial dimensions and channel width of the input tensor while preserving semantically meaningful features.

At step 605, discretization module 122 generates discrete latent embeddings 306 based on latent embeddings 305. In various embodiments, discretization module 122 performs a vector quantization operation in which each continuous-valued latent vector included in latent embeddings 305 is replaced with the nearest vector from a learned codebook. The process converts the continuous latent grid into a quantized grid consisting of discrete embedding vectors or corresponding token indices. In some embodiments, discretization module 122 uses a nearest-neighbor matching approach based on Euclidean distance or another similarity metric. The selected codebook entries are substituted for the original latent vectors in latent embeddings 305, resulting in discrete latent embeddings 306, which retain the same spatial structure but contain quantized values. In some embodiments, discretization module 122 supports straight-through gradient estimation or other differentiable approximations to enable end-to-end training of discrete autoencoder 119.

At step 606, reconstruction decoder 123 generates reconstructed compressed object data 303 based on discrete latent embeddings 306. In various embodiments, reconstruction decoder 123 receives a spatial grid included in discrete latent embeddings 306. In some embodiments, reconstruction decoder 123 includes a stack of 3D convolutional layers, transposed convolutions (e.g., deconvolutions), residual blocks, or other neural network components designed to progressively upsample and refine spatial features from the latent space. In some embodiments, reconstruction decoder 123 also includes skip connections, attention mechanisms, normalization layers, and/or the like. In various embodiments, reconstruction decoder 123 reconstructs compressed object data 303 in the same format as the original input to latent encoder 121, such as a wavelet-tree representation.

At step 607, loss calculator 117 generates loss 304 based on reconstructed compressed object data 303 and compressed object data 302. In various embodiments, compressed object data 302 corresponds to a wavelet-tree representation and reconstructed compressed object data 303 corresponds to a reconstructed version generated by reconstruction decoder 123. Loss calculator 117 calculates a reconstruction loss between compressed object data 303 and compressed object data 302 that accounts for both low-frequency and high-frequency components in the wavelet domain. In some examples, the reconstruction loss is calculated as described in Equation 1. In some embodiments, loss calculator 117 also calculates auxiliary loss terms to support vector quantization during training. The auxiliary losses include a codebook loss and a commitment loss. In some embodiments, loss calculator 117 calculates loss 304 based on at least one of the reconstruction loss, the commitment loss, and the codebook loss. For example, loss 304 can be calculated as described in Equation 2.

At step 608, model trainer 115 updates parameters of discrete autoencoder 119 based on loss 304. In various embodiments, model trainer 115 performs gradient-based optimization, such as SGD, Adam, and/or the like, to minimize loss 304 by adjusting the parameters of latent encoder 121, reconstruction decoder 123, and the codebook used by discretization module 122. In some examples, gradients are computed via backpropagation across loss 304, which can include reconstruction, codebook, and commitment losses. In some embodiments, to improve convergence and training stability, model trainer 115 applies additional techniques, such as learning rate scheduling, gradient clipping, parameter regularization, and/or the like. In some embodiments, model trainer 115 initially trains discrete autoencoder 119 using a large corpus of training samples collected from multiple datasets. For example, the training data (e.g., object data 125) can include millions of samples aggregated from heterogeneous sources, such as CAD models, scanned objects, or synthetic assets. Whenever the training dataset distribution is imbalanced (e.g., skewed toward simpler objects), model trainer 115 applies a balanced fine-tuning stage following the initial training phase. During balanced fine-tuning, model trainer 115 exposes discrete autoencoder 119 to an equal number of samples from each dataset or object category to mitigate dataset bias and improve generalization across underrepresented or more complex 3D shapes.

At step 609, model trainer 115 checks whether to continue training. In some embodiments, model trainer 115 trains discrete autoencoder 119 until a specified stopping criterion is met. In some embodiments, the stopping criterion is based on convergence of loss 304, such as when loss 304 plateaus or falls below a predefined threshold. In some embodiments, training stops after a fixed number of epochs, iterations, or wall-clock time, or based on early-stopping criteria evaluated on a validation set (e.g., when a validation loss does not improve for a predefined number of checkpoints). Whenever model trainer 115 determines not to continue training, the method 500 proceeds to step 503. Whenever model trainer 115 determines to continue training, the method 500 returns to step 601, wherein object data processing module 116 receives another sample from object data 125.

FIG. 7 is a flow diagram of method steps for training generative diffusion model 124, according to various embodiments. Although the method steps are described in conjunction with the systems of FIGS. 1-4, persons skilled in the art will understand that any system configured to perform the method steps in any order falls within the scope of the present disclosure.

As shown, step 503 of the method 500 begins with step 701, wherein generative diffusion model 124 receives object latent embedding data 126, conditions 312, and noise 311. In various embodiments, object latent embedding data 126 includes clean latent embeddings, which encodes a compressed representation of an object. For example, object latent embedding data 126 can be generated by processing compressed representations of object data 125 using the trained latent encoder 121. In various embodiments, noise 311 is generated according to a noise schedule, such as the cosine noise schedule. Conditions 312, such as single-view or multi-view images, voxelizations, point clouds, texts, sketches, and/or the like, are received from one or more I/O devices.

At step 702, generative diffusion model 124 performs forward diffusion steps to generate predicted noise 314 based on object latent embedding data 126, conditions 312, and noise 311. In various embodiments, generative diffusion model 124 performs forward diffusion steps to generate a noisy latent embedding by corrupting a clean latent embedding included in object latent embedding data 126 with Gaussian noise 311 according to a noise schedule, such as the cosine noise schedule. In some examples, forward corruption is described by Equation 3. The noise corruption process generates a latent variable that becomes increasingly noisy with larger timesteps. In some embodiments, generative diffusion model 124 includes pre-trained condition encoders that process conditions 312 and generate a condition vector. In some embodiments, generative diffusion model 124 includes cross-attention mechanisms and feature modulation to process condition vectors. In some examples, generative diffusion model 124 is implemented as a U-ViT generator, where the condition vector influences the generation process by acting as the source of keys and values in the cross-attention layers and by modulating the normalization parameters in ResNet and cross-attention blocks. In various embodiments, generative diffusion model 124 is parameterized by a neural network function, which includes a set of parameters, for example, as described in Equation 4.

At step 703, loss calculator 117 calculates loss 315 based on predicted noise 314 and noise 311. In some examples, loss calculator 117 computes a denoising loss 315 based on noise 311 and predicted noise 314 using a mean squared error function as described in Equation 5.

At step 704, model trainer 115 updates parameters of generative diffusion model 124 based on loss 315. In various embodiments, model trainer 115 performs gradient-based optimization, such as SGD, Adam, and/or the like, to minimize the denoising loss 315 by adjusting the parameters of the generative diffusion model 124. In some embodiments, model trainer 115 trains generative diffusion model 124 iteratively over batches of training samples that include clean latent embeddings included in object latent embedding data 126, sampled noise 311, conditions 312, and diffusion timesteps. To ensure stability and generalization across different noise levels, the timestep is sampled uniformly from a fixed range and the corresponding scaling coefficients are derived from a noise schedule, such as a cosine noise schedule. In some embodiments, model trainer 115 applies learning rate scheduling, gradient clipping, mixed-precision training, and/or the like, to improve convergence efficiency.

At step 705, model trainer 115 checks whether to continue training. In some embodiments, training of generative diffusion model 124 continues until a predefined stopping criterion is met. For example, model trainer 115 could terminate training after a fixed number of epochs, after a convergence threshold is reached for loss 315, or based on early-stopping criteria measured on a validation dataset. Whenever model trainer 115 determines not to continue training, the method 500 terminates. Whenever model trainer 115 determines to continue training, the method 500 returns to step 701.

FIG. 8 is a flow diagram of method steps for generating predicted virtual objects 402, according to various embodiments. Although the method steps are described in conjunction with the systems of FIGS. 1-4, persons skilled in the art will understand that any system configured to perform the method steps in any order falls within the scope of the present disclosure.

As shown, a method 800 begins with step 801, wherein virtual object generation application 146 receives conditions 401. In some embodiments, conditions 401 include one or more input modalities, such as single-view or multi-view images, depth maps, sketches, point clouds, voxel grids, text, and/or the like, and are received from one or more I/O devices.

At step 802, virtual object generation application 146 performs backward diffusion steps, using trained generative diffusion model 124, to generate predicted latent embedding 403 based on conditions 401. In some embodiments, trained generative diffusion model 124 includes one or more modality-specific condition encoders that process conditions 401 and generate a shared conditioning vector. In some embodiments, virtual object generation application 146 initially samples a latent tensor representing an isotropic Gaussian noise sample in the latent embedding space. Virtual object generation application 146 then performs one or more backward diffusion steps using trained generative diffusion model 124 to progressively refine the latent tensor. At each timestep, trained generative diffusion model 124 receives the current latent tensor, the timestep, and the condition vector and predicts the noise using Equation 4. Using the predicted noise, virtual object generation application 146 computes the denoised latent. In some examples, virtual object generation application 146 computes the denoised latent based on the standard DDPM reverse update rule as described in Equation 6. Once the iteration in Equation 6 reaches t=1, trained generative diffusion model 124 generates predicted latent embedding 403. In some embodiments, virtual object generation application 146 applies classifier-free guidance to steer generation of predicted latent embeddings 403 toward the conditional distribution by interpolating between the unconditional and conditional predictions of trained generative diffusion model 124. In some embodiments, virtual object generation application 146 varies the initial latent tensor to generate multiple diverse outputs for the same input conditions 401.

At step 803, trained reconstruction decoder 123 generates predicted compressed object data 404 based on predicted latent embeddings 403. In some embodiments, trained reconstruction decoder 123 processes predicted latent embedding 403 and transforms predicted latent embedding 403 into a high-resolution output in the same format as the original compressed object data 302, such as a wavelet-tree tensor.

At step 804, output processing module 405 generates predicted virtual object 402 based on predicted compressed object data 404. In some embodiments, output processing module 405 decodes multiscale or frequency-domain representation included in predicted compressed object data 404 into a spatial domain format. For example, when predicted compressed object data 404 is represented as a wavelet-tree tensor, output processing module 405 performs an inverse wavelet transform to reconstruct the underlying volumetric field or surface representation. In some embodiments, output processing module 405 also performs auxiliary operations over the spatial domain format, such as scaling, translation, alignment to a canonical frame, or metadata attachment.

In sum, techniques are disclosed for generating virtual objects using latent diffusion models. In various embodiments, a model trainer trains a discrete autoencoder with object data. The discrete autoencoder includes, without limitation, a latent encoder, a discretization module, and a reconstruction decoder. During the training of the discrete autoencoder, an object data processing module processes the object data and generates processed object data. Additionally, an object data compression module processes the processed object data and generates compressed object data. The latent encoder processes the compressed object data and generates one or more latent embeddings. The discretization module then processes the latent embeddings and generates one or more discrete latent embeddings. The reconstruction decoder processes the discrete latent embeddings and generates reconstructed compressed object data. A loss calculator compares the compressed object data with the reconstructed compressed object data and calculates a first loss. Subsequently, the model trainer uses the first loss to iteratively update one or more parameters of the discrete autoencoder until one or more stopping criteria are satisfied.

In some embodiments, the model trainer also trains a generative diffusion model using object latent embedding data and one or more conditions. In some examples, the object latent embedding data can be generated by processing the object data using the trained latent encoder. When training the generative diffusion model, the model trainer performs one or more forward diffusion steps to iteratively add noise to object latent embeddings included in the object latent embedding data, and the generative diffusion model generates a predicted noise. The loss calculator compares the noise with the predicted noise and calculates a second loss. The model trainer then uses the second loss to iteratively update one or more parameters of the generative diffusion model until one or more stopping criteria are met.

Once the generative diffusion model is trained, a virtual object generation application employs the trained generative diffusion model, the trained reconstruction decoder, and an output processing module to process one or more conditions and generate a predicted virtual object. During inference, the trained generative diffusion model performs one or more backward diffusion steps to process the conditions and generate a predicted latent embedding. The trained reconstruction decoder processes the predicted latent embedding and generates predicted compressed object data. The output processing module processes the predicted compressed object data and generates the predicted virtual object.

At least one technical advantage of the disclosed techniques relative to the prior art is that the disclosed techniques include training a discrete autoencoder, which permits converting compressed object data into lower-dimensional latent embeddings. The disclosed techniques also include training a generative diffusion model using latent embedding data rather than the higher-dimensional compressed object data, which reduces memory consumption and computation time per sample object data. These technical advantages provide one or more technological improvements over prior art approaches.

1. In some embodiments, a computer-implemented method for generating virtual objects comprises generating, based on object data, compressed object data, performing, based on the compressed object data, one or more operations to train an untrained machine learning model to generate a trained machine learning model that comprises a trained decoder, wherein the trained machine learning model is trained to generate a reconstruction of the compressed object data, and generating, based on one or more conditions, a predicted virtual object using a trained diffusion model and the trained decoder.

2. The computer-implemented method for claim 1, wherein the object data comprises at least one of one or more digital representations of physical objects or one or more digital representations of synthetic objects.

3. The computer-implemented method for claim 1, wherein generating the compressed object data comprises generating, based on the object data, processed object data, and generating, based on the processed object data, the compressed object data.

4. The computer-implemented method for claim 3, wherein generating the processed object data comprises rasterizing one or more object meshes included in the object data into one or more truncated signed distance fields.

5. The computer-implemented method for claim 3, wherein generating the compressed object data comprises applying a three-dimensional wavelet transform to the processed object data.

6. The computer-implemented method of any of clauses 1-5, wherein performing one or more operations to train the untrained machine learning model comprises generating, based on the compressed object data, one or more latent embeddings using an untrained encoder, generating, based on the one or more latent embeddings, one or more discrete latent embeddings, generating, based on the one or more discrete latent embeddings, the reconstruction of the compressed object data using an untrained decoder, generating, based on the reconstruction of the compressed object data and the compressed object data, a loss, and updating, based on the loss, one or more parameters of the untrained machine learning model.

7. The computer-implemented method of any of clauses 1-6, further comprising generating, based on the object data, object latent embedding data using a trained encoder, and performing, based on the object latent embedding data, one or more operations to train an untrained diffusion model to generate the trained diffusion model.

8. The computer-implemented method of any of clauses 1-7, wherein generating the predicted virtual object comprises receiving the one or more conditions from one or more I/O devices, generating, based on the one or more conditions, one or more predicted latent embeddings using the trained diffusion model, generating, based on the one or more predicted latent embeddings, predicted compressed object data, and generating, based on the predicted compressed object data, the predicted virtual object.

9. The computer-implemented method of any of clauses 1-8, wherein generating the predicted virtual object comprises applying an inverse wavelet transform to the predicted compressed object data.

10. The computer-implemented method of any of clauses 1-9, where the one or more conditions comprises at least one of a single-view image, a multi-view image, one or more point clouds, one or more voxelizations, one or more depth maps, a text, or a sketch.

11. In some embodiments, one or more non-transitory computer-readable media store instructions that, when executed by one or more processors, cause the one or more processors to perform the steps of generating, based on object data, compressed object data, performing, based on the compressed object data, one or more operations to train an untrained machine learning model to generate a trained machine learning model that comprises a trained decoder, wherein the trained machine learning model is trained to generate a reconstruction of the compressed object data, and generating, based on one or more conditions, a predicted virtual object using a trained diffusion model and the trained decoder.

12. The one or more non-transitory computer-readable media of clause 11, wherein generating the compressed object data comprises generating, based on the object data, processed object data, and generating, based on the processed object data, the compressed object data.

13. The one or more non-transitory computer-readable media of clauses 11 or 12, wherein generating the processed object data comprises rasterizing one or more object meshes included in the object data into one or more truncated signed distance fields.

14. The one or more non-transitory computer-readable media of any of clauses 11-13, wherein generating the compressed object data comprises applying a three-dimensional wavelet transform to the processed object data.

15. The one or more non-transitory computer-readable media of any of clauses 11-14, wherein performing one or more operations to train the untrained machine learning model comprises generating, based on the compressed object data, one or more latent embeddings using an untrained encoder, generating, based on the one or more latent embeddings, one or more discrete latent embeddings, generating, based on the one or more discrete latent embeddings, the reconstruction of the compressed object data using an untrained decoder, generating, based on the reconstruction of the compressed object data and the compressed object data, a loss, and updating, based on the loss, one or more parameters of the untrained machine learning model.

16. The one or more non-transitory computer-readable media of any of clauses 11-15, wherein the loss comprises at least one of a reconstruction loss, a codebook loss, or a commitment loss.

17. The one or more non-transitory computer-readable media of any of clauses 11-16, wherein the instructions, when executed by the one or more processors, further cause the one or more processors to perform the steps of generating, based on the object data, object latent embedding data using a trained encoder, and performing, based on the object latent embedding data, one or more operations to train an untrained diffusion model to generate the trained diffusion model.

18. The one or more non-transitory computer-readable media of any of clauses 11-17, wherein generating the compressed object data comprises generating, based on the object data, processed object data, and generating, based on the processed object data, the compressed object data.

19. The one or more non-transitory computer-readable media of any of clauses 11-18, wherein the untrained machine learning model comprises a vector-quantized autoencoder.

20. In some embodiments, a system comprises one or more memories storing instructions, and one or more processors that are coupled to the one or more memories and, when executing the instructions, are configured to generate, based on object data, compressed object data, perform, based on the compressed object data, one or more operations to train an untrained machine learning model to generate a trained machine learning model that comprises a trained decoder, wherein the trained machine learning model is trained to generate a reconstruction of the compressed object data, and generate, based on one or more conditions, a predicted virtual object using a trained diffusion model and the trained decoder.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating virtual objects comprises:
generating, based on object data, compressed object data;
performing, based on the compressed object data, one or more operations to train an untrained machine learning model to generate a trained machine learning model that comprises a trained decoder, wherein the trained machine learning model is trained to generate a reconstruction of the compressed object data; and
generating, based on one or more conditions, a predicted virtual object using a trained diffusion model and the trained decoder.

2. The computer-implemented method for claim 1, wherein the object data comprises at least one of one or more digital representations of physical objects or one or more digital representations of synthetic objects.

3. The computer-implemented method for claim 1, wherein generating the compressed object data comprises:
generating, based on the object data, processed object data; and
generating, based on the processed object data, the compressed object data.

4. The computer-implemented method for claim 3, wherein generating the processed object data comprises rasterizing one or more object meshes included in the object data into one or more truncated signed distance fields.

5. The computer-implemented method for claim 3, wherein generating the compressed object data comprises applying a three-dimensional wavelet transform to the processed object data.

6. The computer-implemented method of claim 1, wherein performing one or more operations to train the untrained machine learning model comprises:
generating, based on the compressed object data, one or more latent embeddings using an untrained encoder;
generating, based on the one or more latent embeddings, one or more discrete latent embeddings;
generating, based on the one or more discrete latent embeddings, the reconstruction of the compressed object data using an untrained decoder;
generating, based on the reconstruction of the compressed object data and the compressed object data, a loss; and
updating, based on the loss, one or more parameters of the untrained machine learning model.

7. The computer-implemented method of claim 6, further comprising:
generating, based on the object data, object latent embedding data using a trained encoder; and
performing, based on the object latent embedding data, one or more operations to train an untrained diffusion model to generate the trained diffusion model.

8. The computer-implemented method of claim 1, wherein generating the predicted virtual object comprises:
receiving the one or more conditions from one or more I/O devices;
generating, based on the one or more conditions, one or more predicted latent embeddings using the trained diffusion model;
generating, based on the one or more predicted latent embeddings, predicted compressed object data; and
generating, based on the predicted compressed object data, the predicted virtual object.

9. The computer-implemented method of claim 8, wherein generating the predicted virtual object comprises applying an inverse wavelet transform to the predicted compressed object data.

10. The computer-implemented method of claim 1, where the one or more conditions comprises at least one of a single-view image, a multi-view image, one or more point clouds, one or more voxelizations, one or more depth maps, a text, or a sketch.

11. One or more non-transitory computer-readable media storing instructions that, when executed by one or more processors, cause the one or more processors to perform the steps of:
generating, based on object data, compressed object data;
performing, based on the compressed object data, one or more operations to train an untrained machine learning model to generate a trained machine learning model that comprises a trained decoder, wherein the trained machine learning model is trained to generate a reconstruction of the compressed object data; and
generating, based on one or more conditions, a predicted virtual object using a trained diffusion model and the trained decoder.

12. The one or more non-transitory computer-readable media of claim 11, wherein generating the compressed object data comprises:
generating, based on the object data, processed object data; and
generating, based on the processed object data, the compressed object data.

13. The one or more non-transitory computer-readable media of claim 12, wherein generating the processed object data comprises rasterizing one or more object meshes included in the object data into one or more truncated signed distance fields.

14. The one or more non-transitory computer-readable media of claim 12, wherein generating the compressed object data comprises applying a three-dimensional wavelet transform to the processed object data.

15. The one or more non-transitory computer-readable media of claim 11, wherein performing one or more operations to train the untrained machine learning model comprises:
generating, based on the compressed object data, one or more latent embeddings using an untrained encoder;
generating, based on the one or more latent embeddings, one or more discrete latent embeddings;
generating, based on the one or more discrete latent embeddings, the reconstruction of the compressed object data using an untrained decoder;
generating, based on the reconstruction of the compressed object data and the compressed object data, a loss; and
updating, based on the loss, one or more parameters of the untrained machine learning model.

16. The one or more non-transitory computer-readable media of claim 15, wherein the loss comprises at least one of a reconstruction loss, a codebook loss, or a commitment loss.

17. The one or more non-transitory computer-readable media of claim 15, wherein the instructions, when executed by the one or more processors, further cause the one or more processors to perform the steps of:
generating, based on the object data, object latent embedding data using a trained encoder; and
performing, based on the object latent embedding data, one or more operations to train an untrained diffusion model to generate the trained diffusion model.

18. The one or more non-transitory computer-readable media of claim 11, wherein generating the compressed object data comprises:
generating, based on the object data, processed object data; and
generating, based on the processed object data, the compressed object data.

19. The one or more non-transitory computer-readable media of claim 11, wherein the untrained machine learning model comprises a vector-quantized autoencoder.

20. A system comprising:
one or more memories storing instructions, and
one or more processors that are coupled to the one or more memories and, when executing the instructions, are configured to:
generate, based on object data, compressed object data,
perform, based on the compressed object data, one or more operations to train an untrained machine learning model to generate a trained machine learning model that comprises a trained decoder, wherein the trained machine learning model is trained to generate a reconstruction of the compressed object data, and
generate, based on one or more conditions, a predicted virtual object using a trained diffusion model and the trained decoder.
